(19) United States
(12) Patent Application Publication
(10) Pub. No.: US 2014/0326636 A1
(43) Pub. Date: Nov. 6, 2014

(54) Smart Pillboxes

(71) Applicant: Robert Baschnagel, Garden City, NY (US)

(72) Inventor: Robert Baschnagel, Garden City, NY (US)

(21) Appl. No.: 13/874,497

(22) Filed: May 1, 2013

(51) Int. Cl. A61J 1/03; B65D 5/52

(52) U.S. Cl. CPC A61J 1/03; B65D 5/5206
USPC 206/538; 206/45.2

(57) ABSTRACT

A portable smart pillbox is disclosed in the present invention. Said portable smart pillbox comprises of a plurality of medication compartments and a mobile phone stand with a charger groove to receive mobile phone chargers. Said smart pillboxes can used in combination of mobile phones. The smart pillboxes can hold and charge mobile phones and users of smart pillbox can use their mobile phones and apps in their mobile phones to remind them the right time and kind of medications they should take.

### CROSS-REFERENCE

This is a continuation-in-part Application to the U.S. application Ser. No. 13/766,387, filed on Feb. 13, 2013, from which priority is claimed, and entirety of which is hereby incorporated by reference.

### BACKGROUND OF THE INVENTION

### Field of the Invention

The present invention relates to portable pillboxes. More particularly, it relates to pillboxes that can be used in combination with mobile phones so that users of the pillboxes can schedule the time when to take medicines and be alerted as to when a pill should be taken. As such the present invention incorporates a charging device for a mobile phone or electronic device as a way of intuitively bringing the features of a cell phone together with a pillbox to create one unique unit device.

With continued advances in the field of medicine, people have increasing life spans. As such nowadays, there is more than ever the need to take medications and a need to keep track of proper timing as to when each medication should be taken. In our presend day society, many people take a variety of pills daily. Depending on an individual's medical circumstance, following a strict regimen of taking certain pills at particular times may be important to their treatment.

There are known pillboxes that have been designed to assist users with organizing their medications. Some of these include a plurality of compartments that are arranged, indexed and differentiated in units for use over a selected period of time. Some of these may have timing or alarming device to remind users to take their medications at the right schedule.

For example, U.S. Pat. No. 5,806,670 to Harlan et al. discloses a pocket size portable pill box with subdivideable dual rounded bottom compartments. The pill box may have a make-up kit, a computer, or an audible alarm mounted on the surface of the pill box.

U.S. Pat. No. 5,915,558 to Girvetz discloses a portable pill box with alarm, having a shape which insinuates a pager. It may be used in combination with a pager to remind user about taking his/her medicine.

U.S. Pat. No. 5,990,782 to Lee discloses an electronic pillbox for administering a multiple-drug therapy, including a plurality of compartments for storing different medications, an LCD-based user interface for interacting with a user, and a software-programmable electronic computer for controlling the administration functions of the pillbox.

Nowadays, mobile phones are commonly used in the United States. Many people use their smart phones as management tools for their daily lives. There are various kinds of free Apps designed for smart phone users to program their medication schedule in the phone and remind users when their medications needed to be taken. Therefore, it is of one objective of present invention to have a pillbox that can be used in combination with mobile phones. Users of this pillbox use Apps on their mobile phones to manage and control the administering of medication and remind themselves of the right time for taking their medications. It is also of another objective of present invention to have a pillbox that can be used in combination with mobile phones so that the pillbox will not need to have the added expense of having an electronic or computer device built into the pillbox itself—thus greatly reduce the cost of pillbox. Additionally, the idea of having a cell phone, or app related electronic device, charging component will insure that said pill box will be used in conjunction with said electronic device and be at hand when it is time for a pill or medication to be taken.

### SUMMARY OF THE INVENTION

In an exemplary embodiment of the present invention, there is disclosed a smart pillbox, a portable smart pillbox, comprising a plurality of medication compartments; and a mobile phone stand that can hold a mobile phone in a upright position; and wherein said plurality of medication compartments and said mobile phone stand may be constructed integratedly into one device. Said smart pillboxes can be used in combination with mobile phones. The smart pillboxes can serve as a docking station for holding and charging mobile phones and users of such a smart pillbox can use their mobile phones and apps in their mobile phones to remind them about the right time and kind of medications they should take. Such device which incorporates a pill box can be either a portable or non portable version. One being ideal for travel and the other if there are too many pills to take that would make a portable version of the device impractical. Herein this pillbox utilizes a phone charging system and it is with this incorporation that a user will gravitate to keeping his or her pillbox connected with his or her cell phone and as such an app that reminds the user as to when it is time to take one's medication will insure that said medication is readily at hand.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a prospective view of a smart pillbox with collapsible legs having a mobile phone held with its mobile phone stand.

FIG. 2A is a close up of the base of the invention.

FIG. 2B is a front view of the device.

FIG. 3A is a rear view of said device.

FIG. 3B shows how electronic charger incorporates with device.

FIG. 4 is a prospective view of a smart pillbox with medication compartments attached to the back and bottom of the mobile phone stand.

FIG. 5 is the top view of FIG. 4.

FIG. 6A is a prospective front view of the invention.

FIG. 6B is a top down view showing compartments in the rear of the device.

FIG. 7 is a top down view of FIG. 4 without a mobile phone being held on the mobile phone stand.

FIG. 8A is a close up view of box compartments.

FIG. 8B is a side view of box compartments.

FIG. 9 is a prospective view of a smart pillbox with leather case and the mobile phone stand that is rotatably attached to the leather case.

FIG. 10 is a prospective view of a smart pillbox with leather case showing the medication compartments and lids and covers.

FIG. 11A is a side view of said invention showing various charging attachment devices.

FIG. 11B is a side view of one embodiment of said invention showing cell phone attached to pillbox.

FIG. 12A shows mobile phone stand in one angled position in relation to pillbox compartments.

FIG. 12B shows mobile phone stand in outward position in relation to pillbox compartments.

FIG. 12C shows mobile phone stand in a varied angled position in relation to pillbox compartment.

FIG. 12D shows mobile phone stand locked into varied angled position in relation to pillbox compartment.

FIG. 13A shows top down view of charger groove opening.

FIG. 13B shows one embodiment of charger groove opening with a small sized charging plug incorporated therein.

FIG. 13C shows another embodiment of charger groove opening with a large sized charging plug incorporated therein.

FIG. 13D shows a varying embodiment of charger groove opening with a varied shaped charging plug incorporated therein.

### DESCRIPTION OF THE PREFERRED EMBODIMENT

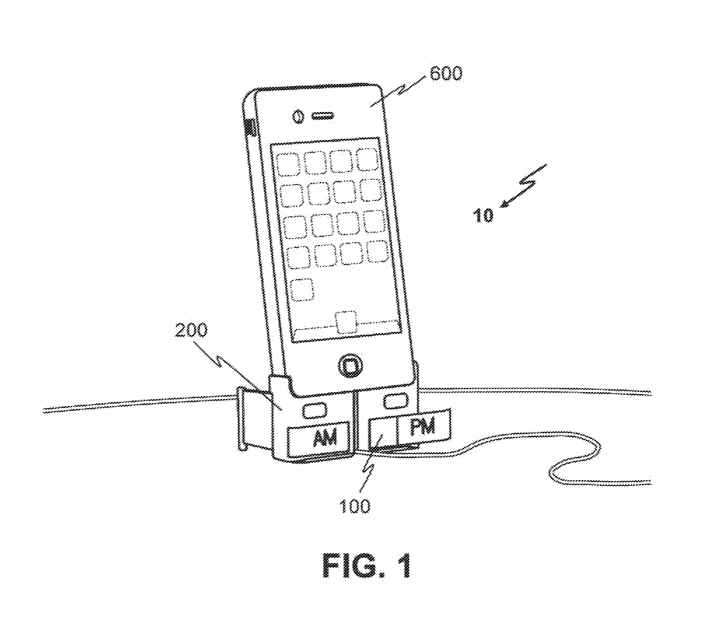

Referring to FIG. 1, there is disclosed a smart pillbox 10, comprising a plurality of medication compartments 100; and a mobile phone stand 200 that can hold a mobile phone 600 in a upright position; and wherein said plurality of medication compartments and said mobile phone stand may be constructed integratedly into one device.

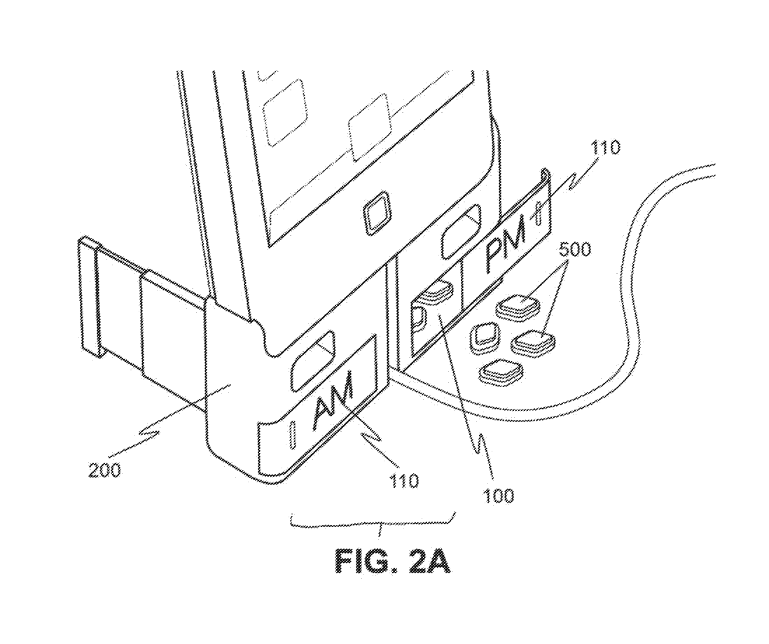

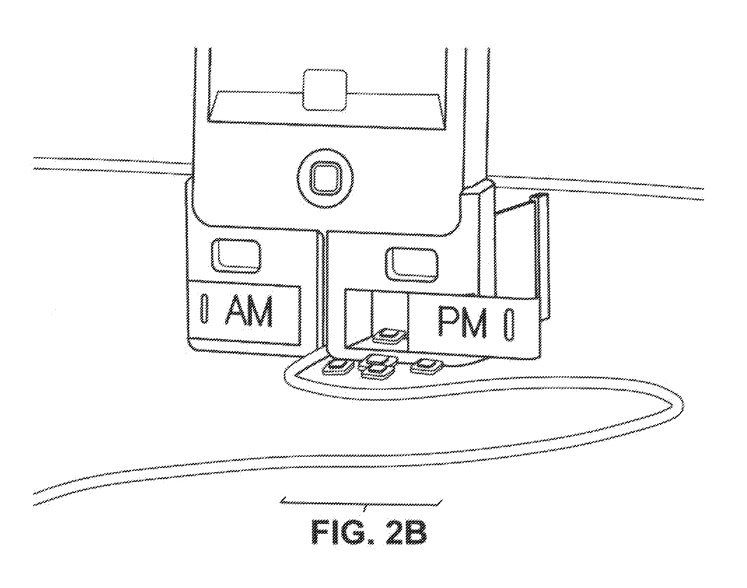

Referring to FIG. 2A and FIG. 2B, different medications 500 can be stored in the medication compartments 100. The medications compartment 100 may have lids or covers 110 that can be labeled or indexed, so that user will not confused about what medication is in each compartment or it can be indexed as when the medication should be taken, like morning medications or evening medications.

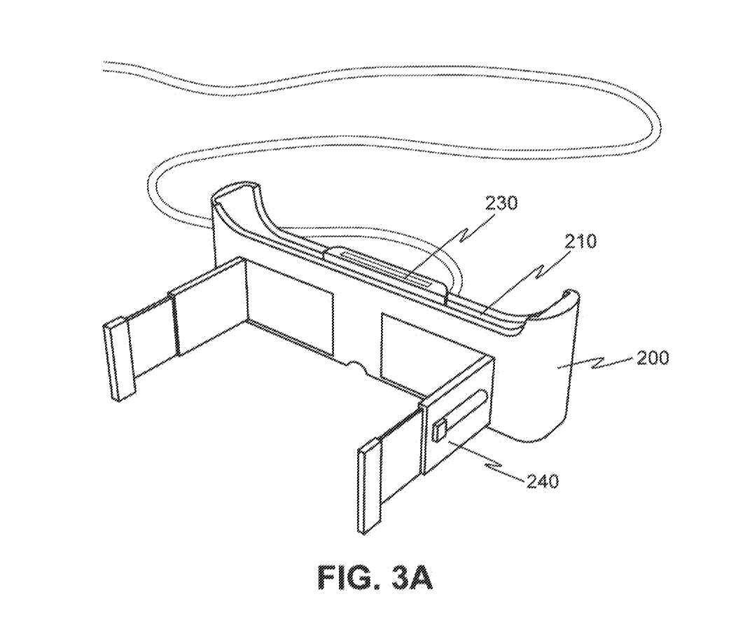

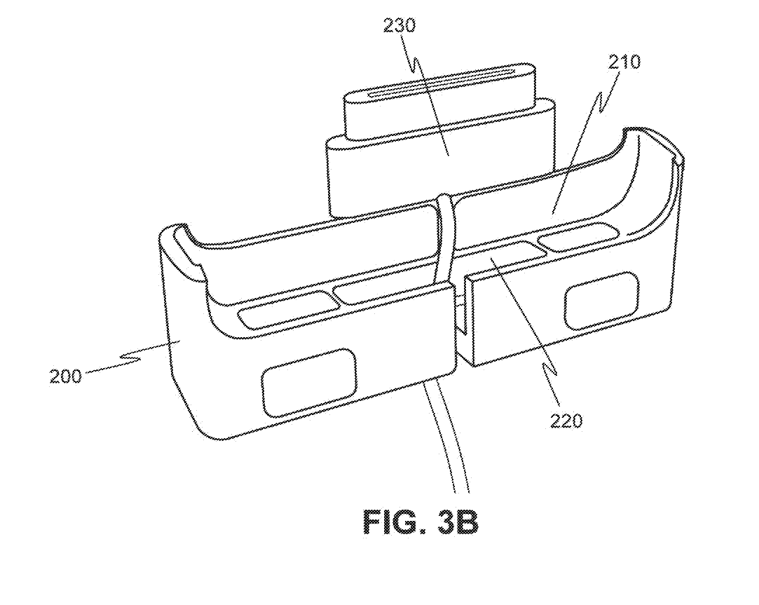

In one embodiment of present invention as referring to FIG. 3A and FIG. 3B, the mobile phone stand 200 may has a base defining a receptacle 210 configured to receive and tightly hold a mobile phone in a upright position. It also has a charger groove 220 to receive a mobile phone charger 230. In some embodiments of the present invention, the mobile phone stand may have collapsible legs 240. These legs can either in an close or open position: when in the close position, said legs collapse into said mobile phone stand and when in the open position, said legs expands from said mobile phone stand. In some of the embodiments of present invention as shown in FIG. 3A, the legs are extendable so that the length of legs are adjustable.

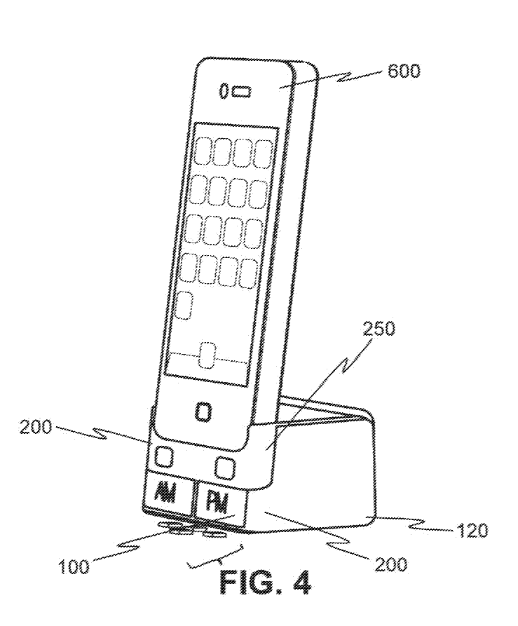

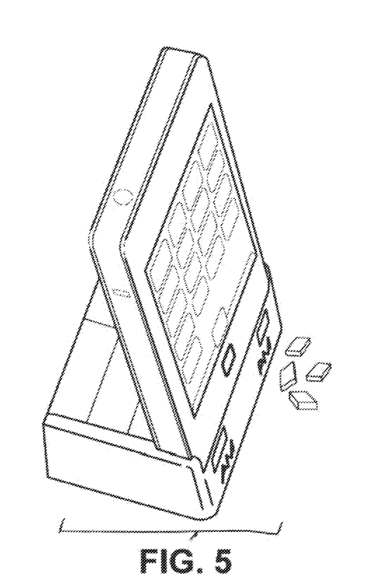

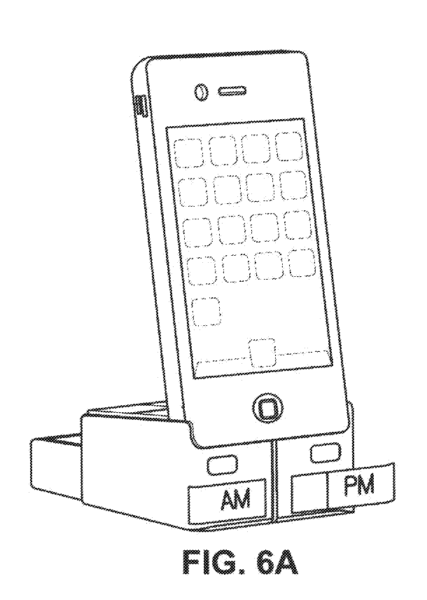

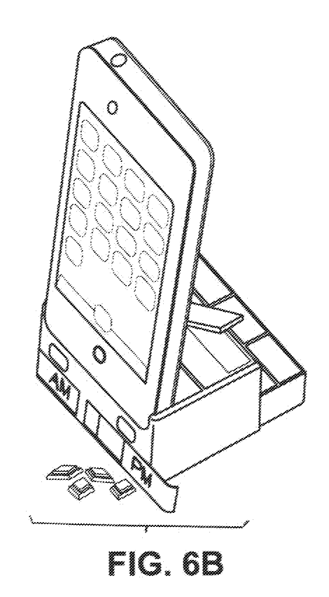

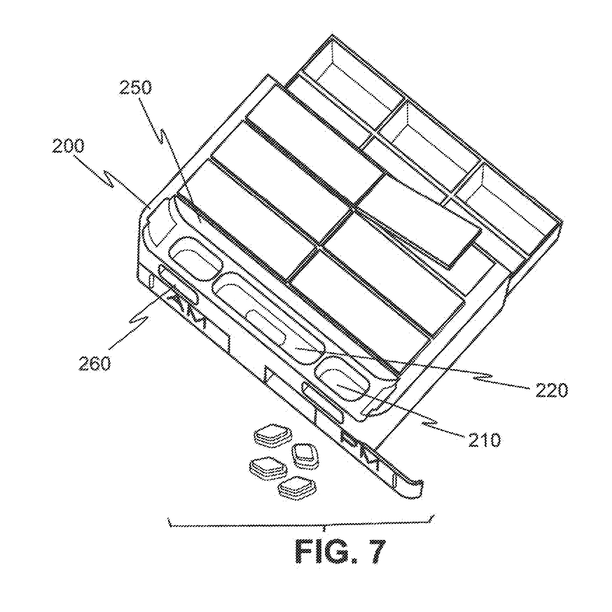

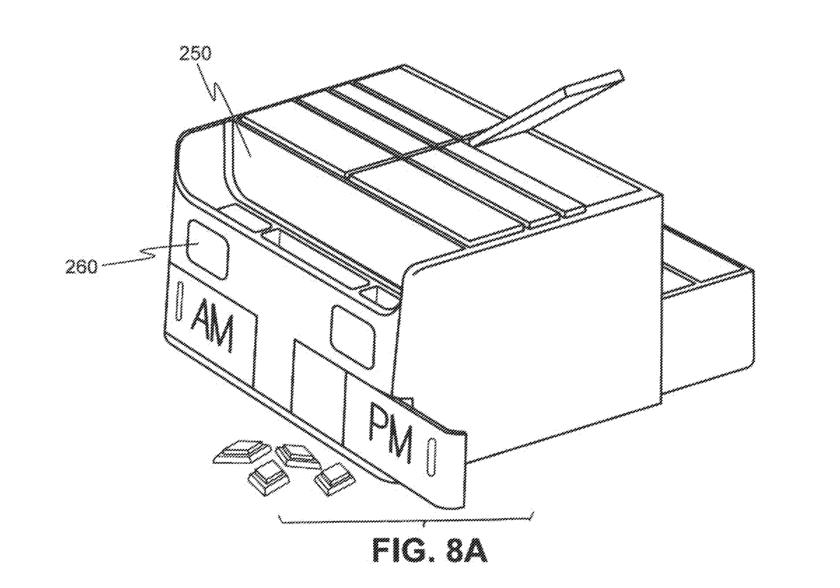

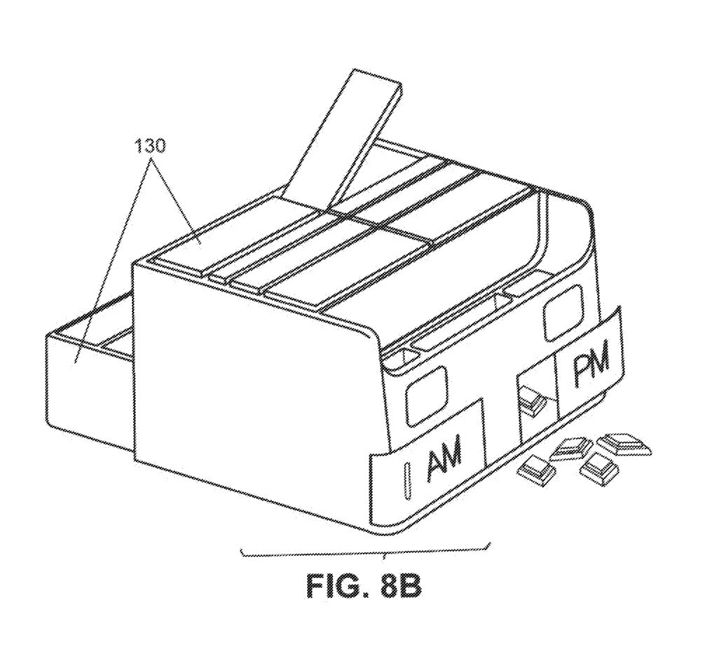

In another embodiment of present invention as shown by FIG. 4, FIG. 5, FIG. 6A, FIG. 6B, FIG. 7, FIG. 8A, and FIG. 8B, mobile phone stand 200 has a back member 250 and a bottom member 260, and said plurality of medication compartments 100 is added to said back and bottom member in such a way that said mobile phone stand and said plurality form an integrated one piece structure with a flat bottom 120. In another embodiment of present invention, additional compartments 130 can be attached depending how many medications a user of said pillbox needs to take.

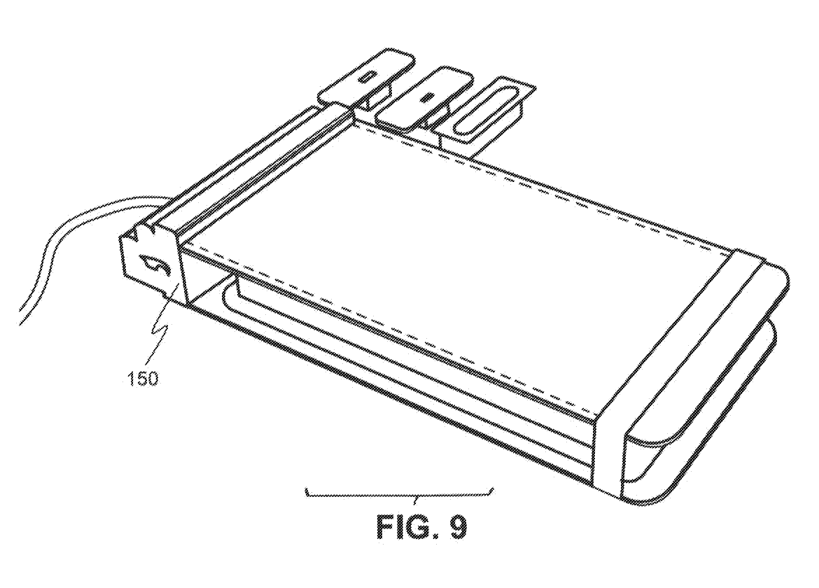

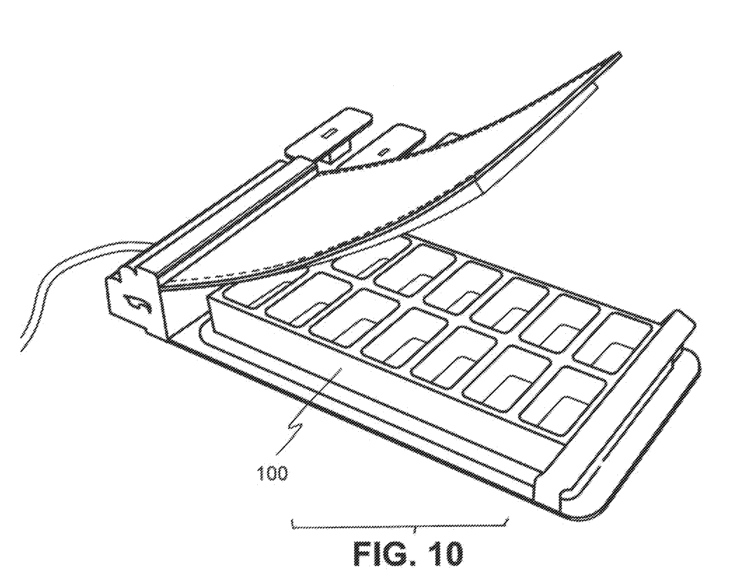

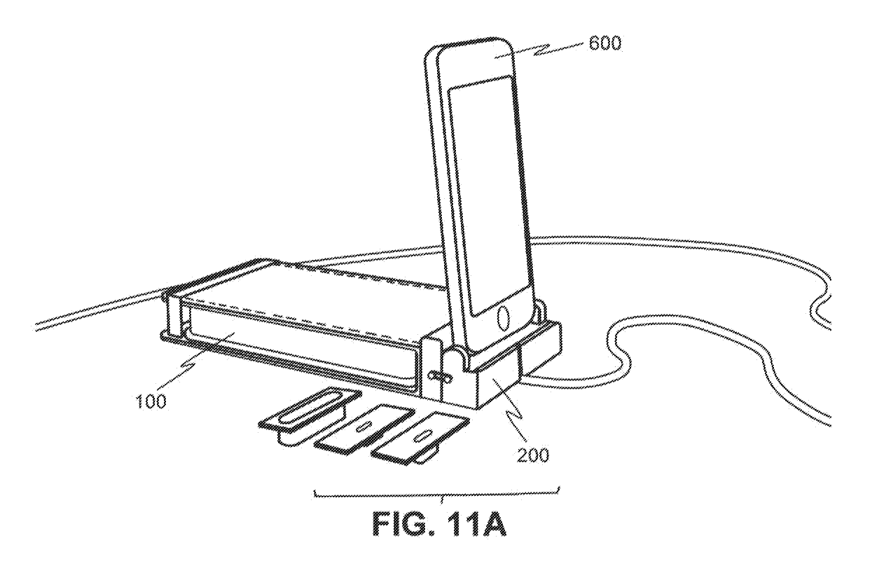

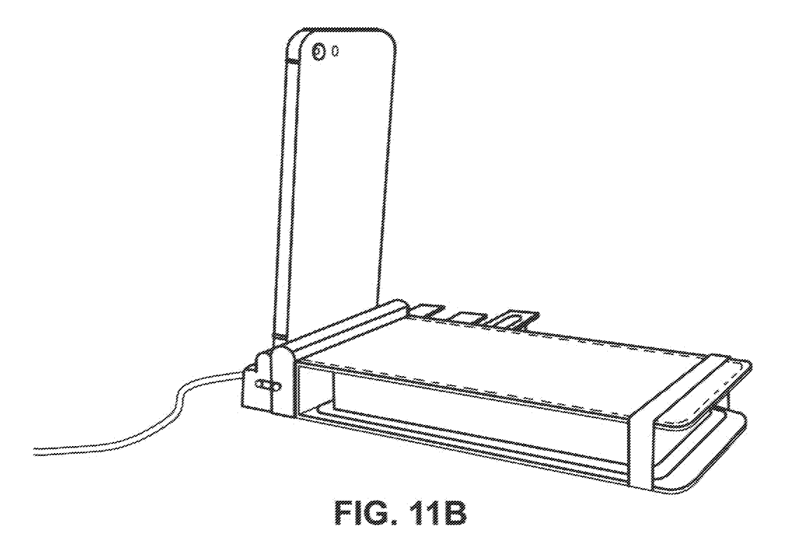

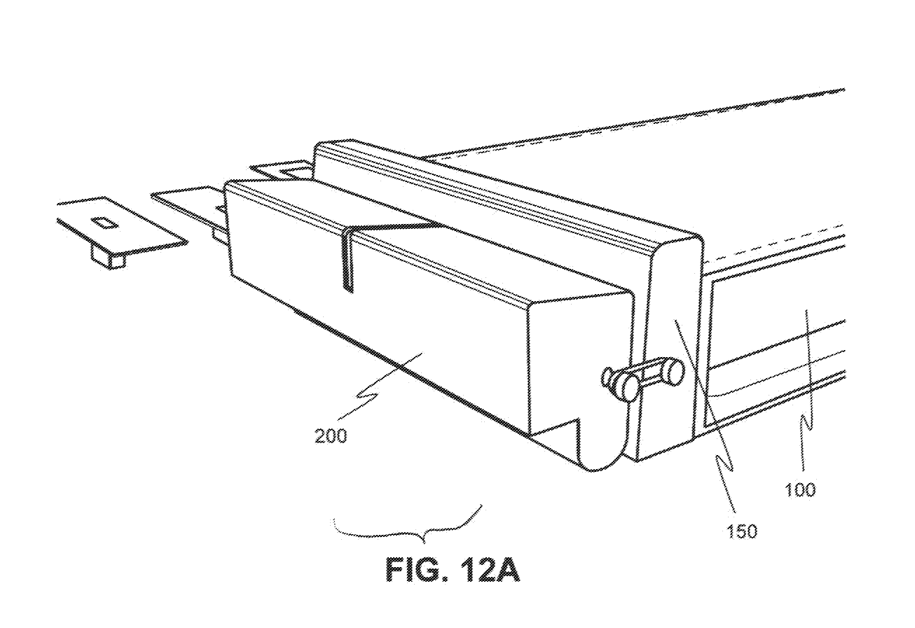

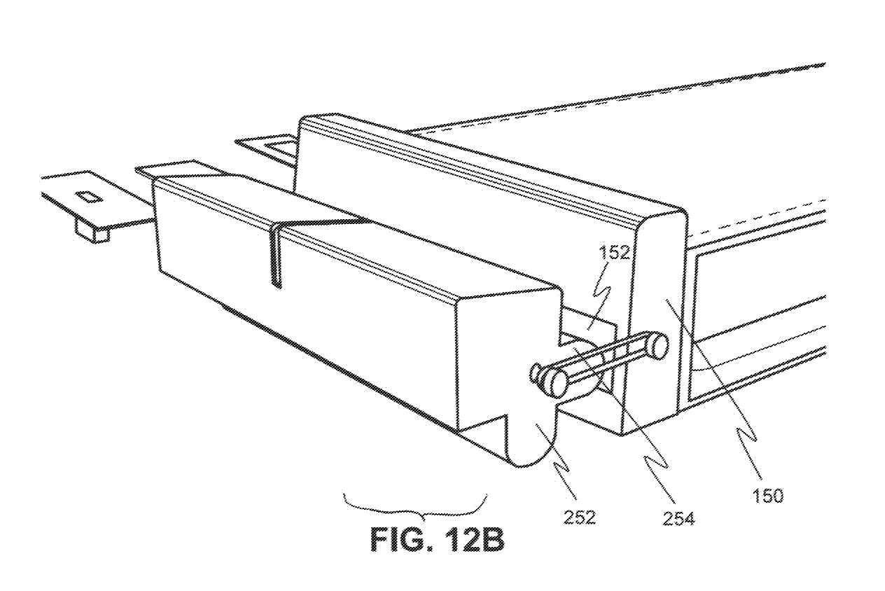

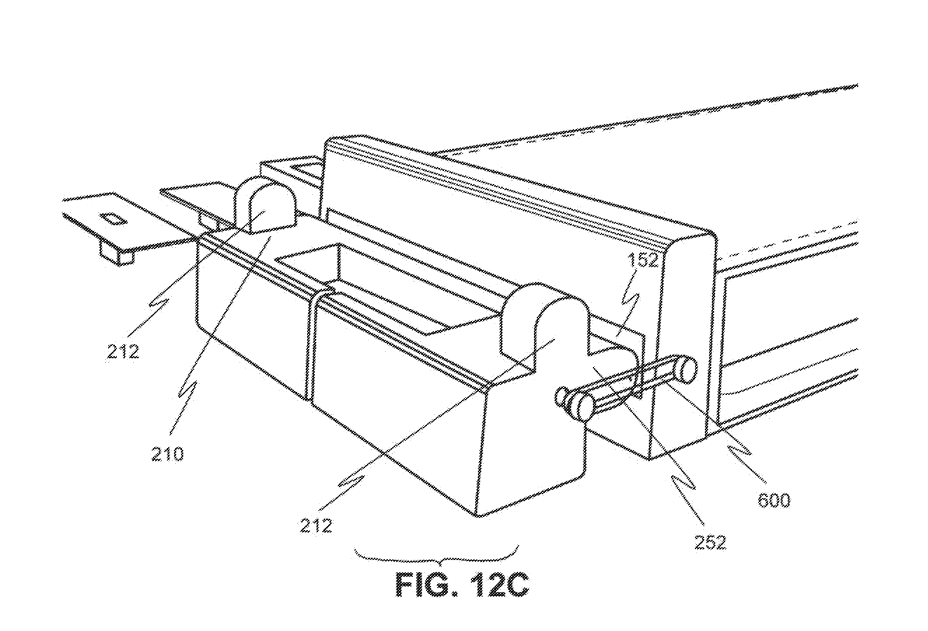

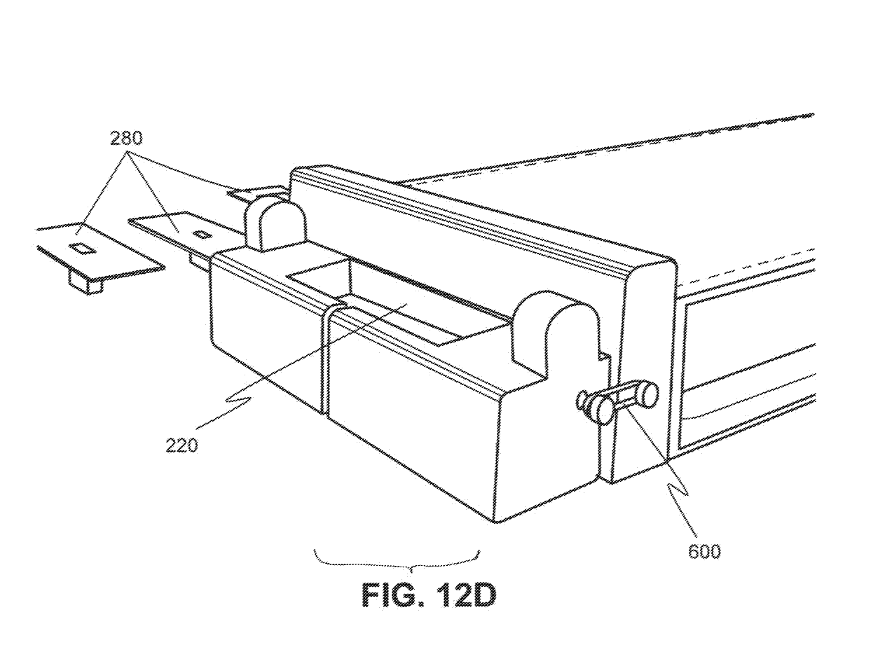

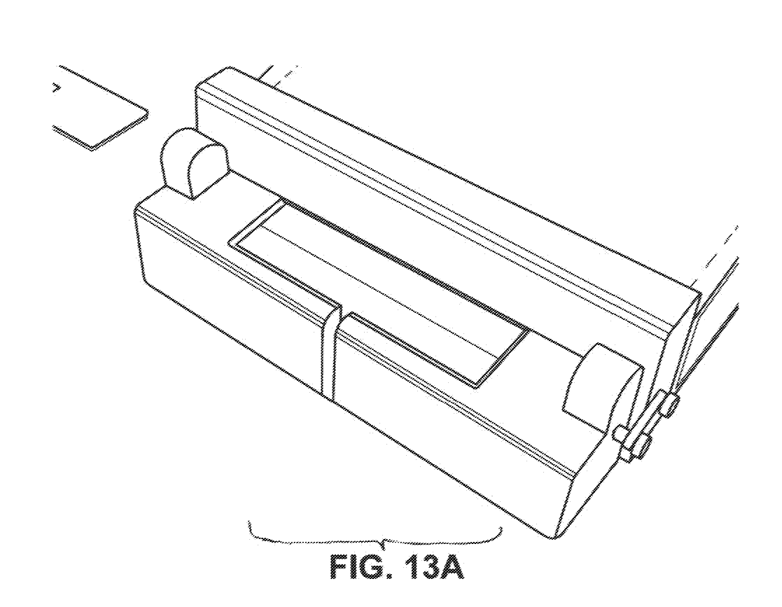

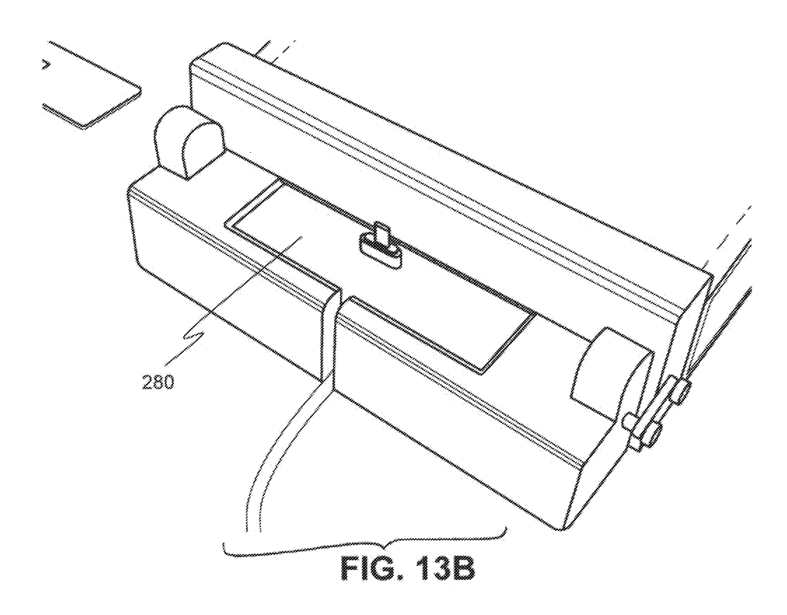

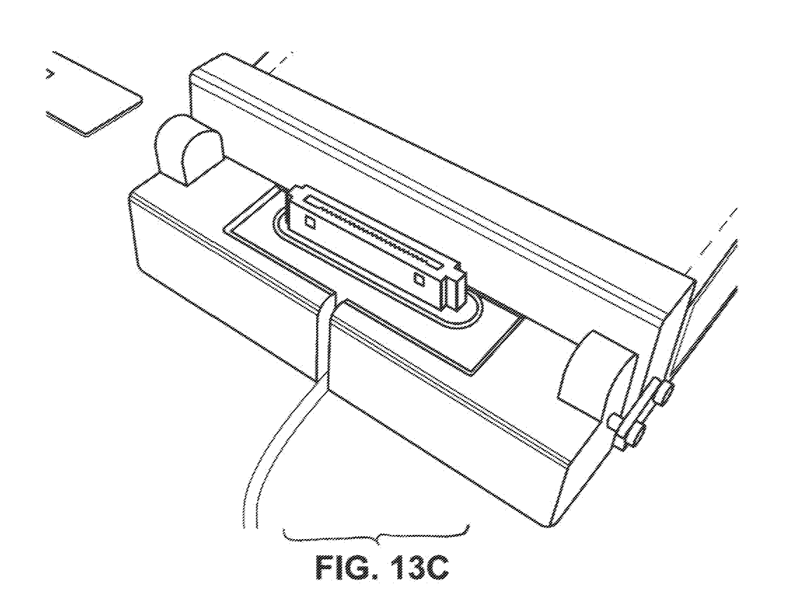

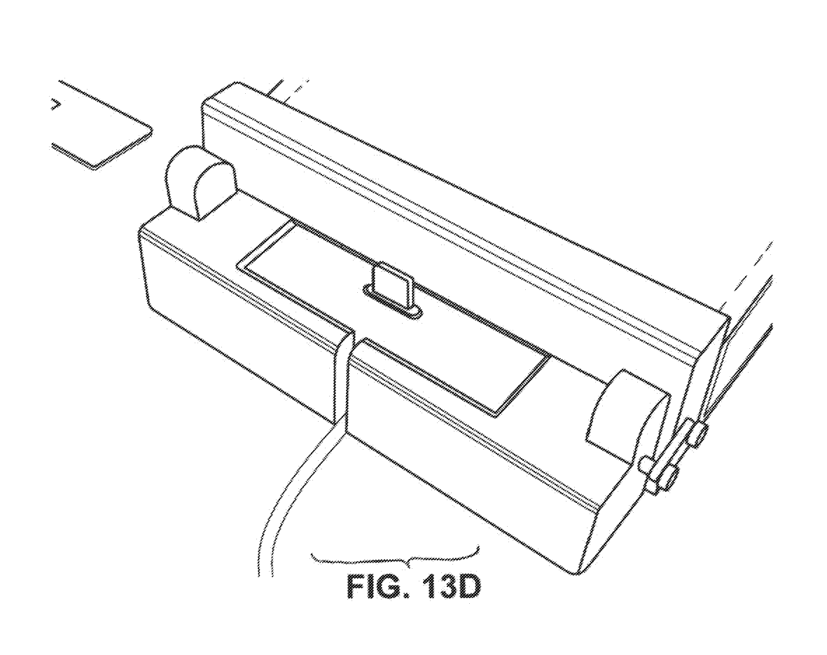

In some other embodiments of present invention as shown by FIG. 9, FIG. 10, FIG. 11A, FIG. 11B, FIG. 12A, FIG. 12B, FIG. 12C, FIG. 12D, FIG. 13A, FIG. 13B, FIG. 13C, and FIG. 13D, a smart pillbox may further comprise a leather case 140 form a leather pouch 142, and said plurality of medication compartments is located in said leather pouch. In another embodiment of the present invention, leather case 140 has a bottom piece 144 and a top piece 146, and said plurality of medication compartments 100 attached to the bottom piece 144, and a plurality of lids or covers 160 attached to the top piece 146.

In another embodiment of the present invention, the medication compartments 100 further comprise a 150 base member attached to said leather case 140, said base member 150 further comprising a receiving groove 152. The mobile phone stand further comprises a back protrusion 252 from back member 250 that can fitly received into said receiving groove 152, It also further comprises two arms 212 extending from said base receptacle 210 and said two arms 212 are configured in such a way that they can also fitly received into said receiving groove 152. In another embodiment of present invention, mobile phone stand 100 is attached together with said base member 150 attached to said leather case 140, by inserting said back protrusion 252 or said arms 212 of mobile phone stand into said receiving groove 152 and fastened together by fasten means 400, for example, a rubber band shown in FIG. 12A, FIG. 12B, FIG. 12C and FIG. 12D. The fasten means are configured to allow said mobile phone stand 100 being pull out from said receiving groove 152 of said base member 150, and to allow said mobile phone stand 100 being rotated so that either said back protrusion 252 or said arms 212 of mobile phone stand is received into said receiving groove 152. Yet in another embodiment of present invention, the mobile phone stand further comprising a plurality of boxes 280, which fit into said charger groove 220 and are able to receive different types of mobile chargers.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A portable smart pillbox, comprising:
a. a plurality of medication compartments; and
b. a mobile phone stand that can hold a mobile phone in a upright position;
wherein said plurality of medication compartments and said mobile phone stand may be constructed integratedly into one device.

2. A portable smart pillbox of claim 1, wherein:
a. said plurality of medication compartments further comprising a plurality of lids or covers, and said lids or covers may be labeled or indexed for different medications;
b. said mobile phone stand further comprising a base defining a receptacle configured to receive the mobile phone, and a charger groove to receive a mobile phone charger.

3. A portable smart pillbox of claim 2, wherein said mobile phone stand further comprising collapsible legs, which can either in an close or open position; when in the close position, said legs collapse into said mobile phone stand and when in the open position, said legs expands from said mobile phone stand.

4. A portable smart pillbox of claim 3, wherein said legs are extendable so said legs are adjustable in length.

5. A portable smart pillbox of claim 2, wherein said mobile phone stand has a back member and a bottom member, and said plurality of medication compartments is added to said back and bottom member in such a way that said mobile phone stand and said plurality form an integrated one piece structure with a flat bottom.

6. A portable smart pillbox of claim 5, wherein additional compartments can be attached depending how many medications a user of said pillbox needs to take.

7. A portable smart pillbox of claim 2, wherein:
a. said plurality of compartment further comprising:
i. a leather case to form a leather pouch, and said plurality of medication compartments is located in said leather pouch;
ii. a base member attached to said leather case, said base member further comprising a receiving groove;
b. said mobile phone stand further comprising:
i. a back protrusion that can fitly received into said receiving groove,
ii. two arms extending from said base receptacle and said two arms are configured in such a way that they can also fitly received into said receiving groove.

8. A portable smart pillbox of claim 7, wherein said mobile phone stand is attached together with said base member attached to said leather case, by inserting said back protrusion or said arms of mobile phone stand into said receiving groove and fastened together by fasten means.

9. A portable smart pillbox of claim 8, wherein said fasten means allow said mobile phone stand being pull out from said receiving groove of said base member, and allow said mobile phone stand being rotated so that either said back protrusion or said arms of mobile phone stand is received into said receiving groove.

10. A portable smart pillbox of claim 9, wherein said leather case has a bottom piece and a top piece, and said plurality of medication compartments attached to the bottom piece, and a plurality of lids or covers attached to the top piece.

11. A portable smart pillbox of claim 10, wherein said mobile phone stand further comprising a plurality of boxes, which fit into said charger groove and are able to receive different types of mobile chargers.
